(19) United States
(12) Patent Application Publication
(10) Pub. No.: US 2026/0302844 A1
(43) Pub. Date: Oct. 1, 2026

(54) STATOR OF AN ELECTRIC MACHINE

(71) Applicant: Robert Bosch GmbH, Stuttgart (DE)

(72) Inventors: Daniel Kuehbacher, Stuttgart (DE); Felix Bensing, Stuttgart (DE); Jannik Stammler, Stuttgart (DE); Thomas Winter, Tamm (DE)

(21) Appl. No.: 19/478,398

(22) PCT Filed: Mar. 20, 2024
(86) PCT No.: PCT/EP2024/057417

§ 371 Date: Oct. 24, 2025

(30) Foreign Application Priority Data
Apr. 26, 2023 (DE) 10 2023 203 859.5

(51) Int. Cl. H02K 1/16; H02K 1/18; H02K 3/24; H02K 9/19; H02K 15/0273; H02K 15/085

(52) U.S. Cl. CPC H02K 1/16; H02K 1/185; H02K 3/24; H02K 9/19; H02K 15/0273; H02K 15/085

(57) ABSTRACT

Stator of an electric machine, comprising a stator laminated core on which stator teeth are provided and which comprises laminations with lamination teeth, wherein the stator laminated core comprises laminations on each of which a leadthrough opening is provided for forming a stator insertion hole for inserting a connecting element, characterized in that—first laminations (6.1) are provided, the leadthrough openings (9) of the first laminations being aligned in the circumferential direction in each case relative to the tooth pole center (8m) of the closest lamination tooth (8) of the respective first lamination (6.1) in a first relative alignment (12),—second laminations (6.2) are provided, the leadthrough openings (9) of the second laminations being aligned in the circumferential direction in each case relative to the tooth pole center (8m) of the closest lamination tooth (8) of the respective second lamination (6.2) in a second relative alignment (13), wherein the first and second relative alignment (12, 13) are opposite each other in the circumferential direction,—the first and second laminations (6.1, 6.2) are arranged in at least one rotation group (15) comprising at least two of the first laminations (6.1) and at least one second lamination (6.2) arranged between the first laminations (6.1),—the connecting elements (11) are alignment elements which can be inserted into the respective stator insertion hole (10) for generating opposite rotation of the laminations (6.1, 6.2) of the respective rotation group (15).

### BACKGROUND

The invention proceeds from a stator of an electric machine.

A stator of an electric machine is already known from DE102019206011 A1, with a stator laminated core on which stator teeth and stator slots formed between the stator teeth are provided and which comprises a stack of laminations. The laminations each have lamination teeth to form the stator teeth. The stator laminated core comprises a plurality of laminations, each of which has at least one leadthrough opening provided for forming at least one stator insertion slot for inserting a connecting element, in particular a pin, a bolt or a screw.

It is known from DE102021204202 A1 that a plurality of support points for the local clamping of the electrical conductors can be created in the stator slots of the stator laminated core by rotating the laminations of the stator laminated core. Between the tooth flanks of each stator slot and the conductor or conductor bundle arranged in the stator slot, there is at least one slot gap, which forms a slot gap channel extending in the axial direction, through which a cooling medium, in particular oil, can flow. The rotation of the laminations is achieved by a rotation tool of a manufacturing device, which grips the laminations on the outer circumference and rotates them in the circumferential direction, for example.

### SUMMARY

The stator of the electric machine according to the invention has the advantage that rotating the laminations for the production of the support points is achieved more easily, in particular without a rotation tool from a manufacturing device, thereby reducing the manufacturing costs of the stator.

According to the invention, this is solved by providing first laminations in the stator laminated core, the leadthrough openings of which are aligned in the circumferential direction relative to the tooth pole center of the closest lamination tooth of the respective first lamination in a first relative alignment, in particular offset by an offset angle α, and by providing second laminations in the stator laminated core, the leadthrough openings of which are each aligned in the circumferential direction relative to the tooth pole center of the closest lamination tooth of the respective second lamination in a second relative alignment, in particular offset by an offset angle α, wherein the first and second relative alignments are opposite in the circumferential direction and, in particular, equal in magnitude. According to the invention, the first and second laminations are arranged in at least one rotation group comprising at least two of the first laminations and at least one second lamination arranged between the first laminations. In addition, according to the invention, the connecting elements are alignment elements that can be inserted into the respective stator slot to generate an opposite rotation of the laminations of the respective rotation group.

The alignment elements may also serve to maintain the rotation generated. For example, the alignment elements are metallic, in particular made of steel.

The opposite rotation of the laminations of the rotation group is achieved by the inserted alignment element displacing the first and second laminations protruding into the stator insertion hole in the circumferential direction.

It is advantageous if a stator yoke connecting the stator teeth is provided, wherein the respective stator insertion hole is formed on a side of the stator yoke facing away from the stator teeth. In this way, the magnetic flux in the stator yoke is not negatively affected or only to a minor extent.

The respective alignment element may be a pin according to a first exemplary embodiment or a sleeve according to a second exemplary embodiment. The alignment elements are in particular inserted into the stator slots with a clearance fit.

It is further advantageous if the alignment element at the leading end comprises a chamfer or conical insertion slope for insertion into the respective stator insertion hole. This makes it easier to displace or rotate the first and second laminations in the circumferential direction.

It is particularly advantageous when the respective alignment element according to the second embodiment is a sleeve through which a fastening screw for fastening the stator laminated core to a machine housing can be inserted. In this way, the stator insertion holes may be used to rotate the first and second laminations, and thus to produce the support points, as well as to secure the stator to the machine housing. The fastening screws inserted through the sleeves extend into threaded holes in the machine housing.

It is very advantageous if the first and second laminations are configured in the same shape and arranged in the stator laminated core in a mirror-image configuration. In this way, only a single type of lamination is required to form a rotation group, making the manufacture of the stator laminated core easier and less expensive.

It is also advantageous if a stator winding extending through the stator slots is provided and that a local clamping of conductor bundles of the stator winding in the stator slots can be achieved by rotating the first and second laminations of the respective rotation group. In particular, a conductor bundle of flat wire conductors is locally clamped in each stator groove at at least two support points. In this way, the conductor bundles of the stator winding are fixed in the stator slots.

It is further advantageous if the conductor bundle of the respective stator groove is enclosed by at least one electrically insulating protective jacket at least in the area of the respective rotation group. In this way, a varnish insulation of the electrical conductors of the conductor bundle is protected from damage by the rotated laminations of the rotation group.

In addition, it is advantageous if third laminations are provided in the stator laminated core, the respective leadthrough opening of which is aligned in a circumferential direction relative to a tooth pole center of a closest lamination to the third lamination in a third relative alignment, in particular centered on the tooth pole center. This ensures that the conductor bundles in the stator slots in the area of the third laminations are spaced apart from the tooth flanks of the respective stator slot, thereby creating the slot gap channels in the respective stator slot. This allows direct cooling of the conductor bundles of the stator winding. The third relative alignment is between the first and second relative alignments.

The invention further relates to an electric machine having a stator according to the invention and having a machine housing, wherein the alignment elements according to the invention project through the stator laminated core and project into recesses, in particular bores, of the machine housing for centering the stator laminated core.

The invention also relates to a method for producing a stator according to the invention comprising the steps of:
stacking a stator laminated core comprising first and second laminations, and in particular third laminations,
inserting the stator winding into the stator slots,
inserting the alignment elements into the stator slots, thereby rotating the first and second laminations opposite to each other about the stator axis and locally clamping the conductor bundles in the stator slots.

The laminations of the stator laminated core are aligned with each other in the circumferential direction prior to insertion of the alignment elements, such that the conductors of the stator winding can be inserted into the stator slots with clearance, in particular resulting in substantially aligned lamination teeth. In this way, a simple axial assembly of the stator winding is enabled, in which the varnish insulation of the conductor is not damaged.

### BRIEF DESCRIPTION OF THE DRAWINGS

Several exemplary embodiments of the invention are shown in simplified form in the drawing and explained in more detail in the following description.

Shown are:

FIG. 1 shows a side view of a part of the stator of an electric machine according to the invention,

FIG. 2 a sectional view of the stator according to the invention with a section of the stator along the line II-II in FIG. 1,

FIG. 3A a first lamination of the stator according to FIG. 1 and FIG. 2,

FIG. 3B a second lamination of the stator according to FIG. 1 and FIG. 2,

FIG. 3C a third lamination of the stator according to FIG. 1 and FIG. 2,

FIG. 4A a partial view of two stator slots of the stator laminated core according to FIG. 2 prior to assembly of an alignment element according to the invention,

FIG. 4B a part of a stator insertion hole of the stator laminated core according to FIG. 1 to FIG. 3 with a rotation group prior to assembly of the alignment element according to the invention according to a first exemplary embodiment,

FIG. 4C a partial view of a stator insertion hole of the stator laminated core according to FIG. 1 to FIG. 3 with a rotation group after assembly of the alignment element according to the invention according to a first exemplary embodiment,

FIG. 4D a partial view of two stator slots of the stator laminated core according to FIG. 2 after assembly of the alignment element according to the invention,

FIG. 5 a second exemplary embodiment of the alignment element according to the invention after assembly,

FIG. 6 the second exemplary embodiment of the alignment element according to the invention after assembly with a fastening screw inserted through the sleeve for fastening the stator to a machine housing.

### DETAILED DESCRIPTION

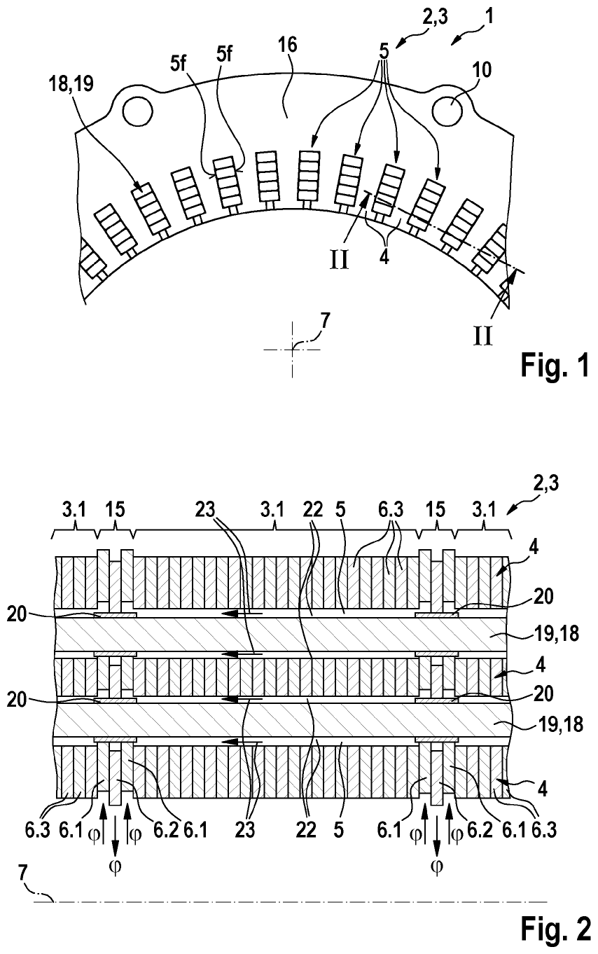

FIG. 1 shows a side view of a part of the stator of an electric machine according to the invention, FIG. 2 shows a sectional view of the stator according to the invention with a section of the stator along the line II-II in FIG. 1,

The stator 2 of an electric machine 1 according to the invention has a stator laminated core 3, on which stator teeth 4 and stator slots 5 formed between the stator teeth 4 are provided, which comprises a stack of laminations 6 and extends about a stator axis 7. The laminations 6 each have lamination teeth 8 to form the stator teeth 4. The lamination teeth 8 are provided on the inner circumference 6i of the laminations 6, for example.

In addition, the laminations 6 each have a plurality of leadthrough holes 9 arranged along the circumference, for example the outer circumference, so that a plurality of stator insertion holes 10 are formed on the stator laminated core 3 for inserting a connecting element 1, in particular a pin, a bolt or a screw. The respective stator insertion hole 10 may be a lead hole or blind hole in the stator laminated core 3. The stator comprises a stator yoke 16 connecting the stator teeth 4, wherein the respective stator insertion hole 10 is formed on a side of the stator yoke 6 facing away from the stator teeth 4. Accordingly, the leadthrough openings 9 of the laminations 6 are also configured on a side of the stator yoke 6 facing away from the stator teeth 4.

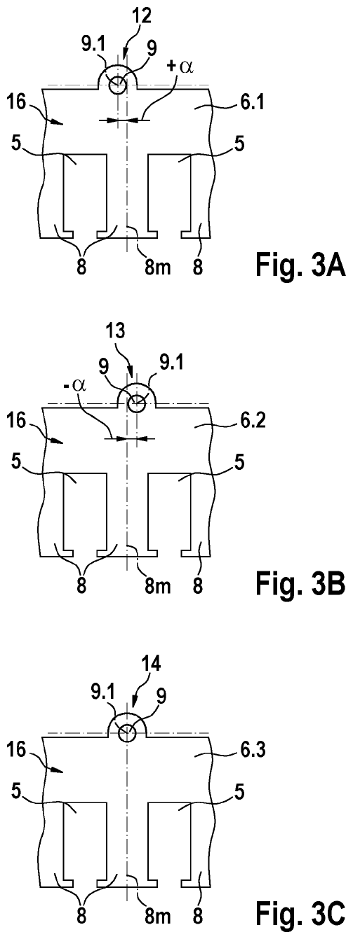

According to the present invention, first laminations 6.1 according to FIG. 3A are provided in the stator laminated core 3, the leadthrough openings 9 of which are respectively aligned in a circumferential direction relative to the tooth pole center 8m of the closest lamination tooth 8 of the respective first lamination 6.1 in a first relative alignment 12, in particular offset by an offset angle α.

In addition, second laminations 6.2 according to FIG. 3B are provided in the stator laminated core 3 according to the invention, the leadthrough openings 9 of which are aligned in the circumferential direction relative to the tooth pole center 8m of the closest laminar tooth 8 of the respective second laminar fin 6.2 in a second relative alignment 13, in particular offset at an offset angle α, wherein the first and second relative alignments 12, 13 are opposite in the circumferential direction and are in particular equal in magnitude.

The first and second laminations 6.1, 6.2 are arranged according to FIG. 2 in at least one rotation group 15 comprising at least two of the first laminations 6.1 and at least one second lamination 6.2 arranged between the first laminations 6.1.

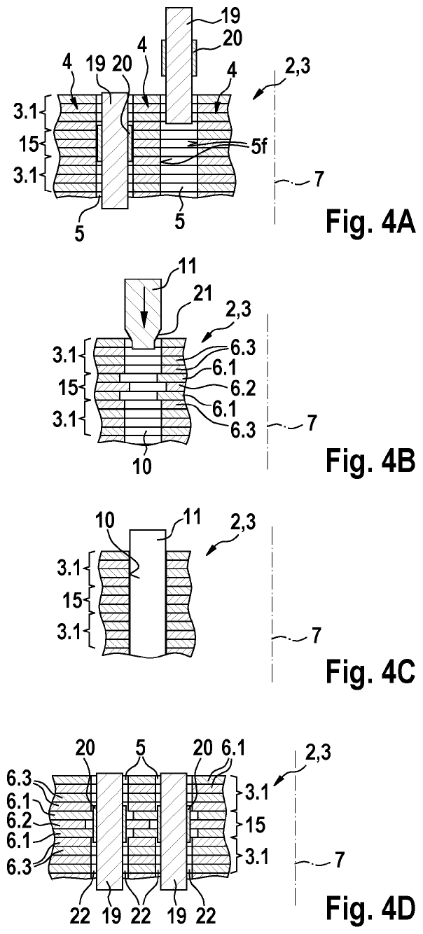

According to the invention, the connecting elements 11 are alignment elements which, according to FIG. 4A and FIG. 4C, can be inserted into the respective stator insertion hole 10 to generate an opposite rotation of the laminations 6.1, 6.2 of the respective rotation group 15, as shown in FIG. 4D.

A first lamination 6.1 of the stator laminated core 3 is shown in section in FIG. 3A and a second lamination 6.2 is shown in section in FIG. 3B, each in a linear representation.

For example, the respective alignment element 11 may be a pin according to a first design example, as shown in FIG. 4B and FIG. 4C.

The opposite rotation of the laminations 6.1, 6.2 of the respective rotation group 15 is achieved by the inserted alignment element 11 displacing sections of the first and second laminations 6.1, 6.2 that protrude into the stator insertion hole 10 in the circumferential direction relative to the stator axis 7, thereby rotating them around the stator axis 7 by a rotation angle φ.

The first and second laminations 6.1, 6.2 can be configured in the same shape and arranged in the stator laminated core 3 in a mirror-image or side-by-side configuration.

In addition, third laminations 6.3 according to FIG. 3C can be provided in the stator laminated core 3, the respective leadthrough opening 9 of which is aligned with respect to its opening axis 9.1 in a circumferential direction relative to a tooth pole center 8m of a closest lamination 8 of the third lamination 6.3 in a third relative direction 14, in particular centered on the tooth pole center 8m. A third lamination 6.3 is shown in a linear representation in FIG. 3C.

The first laminations 6.1 are laminations 6 of a first type, the second laminations 6.2 laminations 6 of a second type, and the third laminations 6.3 laminations 6 of a third type. The first, second and third laminations 6.1, 6.2, 6.3 also comprise the feedthrough openings 9.

The stator 2 includes a stator winding 18 extending through the stator slots 5. A conductor or conductor bundle 19 is arranged in each stator slot 5. The conductor bundle 19 comprises, for example, a stack of flat-wire conductors. By rotating the laminations 6.1, 6.2 of the at least one rotation group 15 according to the invention, a local clamping of the conductor or conductor bundle 19 of the stator winding 18 in the stator slots 5 can be achieved. To ensure that the varnish insulation of the conductor of the conductor bundle 19 is not damaged during the local clamping by the laminations 6.1, 6.2, the conductor or the conductor bundle 19 of the respective stator slot 5 can be enclosed at least in the area of the respective rotation group 15 by at least one electrically insulating protective jacket 20. The protective jacket 20 is designed in a sleeve shape or cuff shape, for example.

The conductor bundles 19 in the stator slots 5 in the area of the third laminations 6.3 are spaced apart from the tooth flanks 5f of the respective stator slot 5, creating slot gap channels 22 in the respective stator slot 5, through which a cooling medium, in particular oil, can flow along a cooling path 23. This allows direct cooling of the conductor bundles 19 of the stator winding 18.

FIG. 4A to FIG. 4D illustrate the process flow after manufacturing the stator laminated core 3.

The manufacture of the stator laminated core 3 comprises stacking laminations 6, wherein the stator laminated core 3 comprises first and second laminations 6.1, 6.2, and in particular third laminations 6.3.

According to one exemplary embodiment, in a first step, first, second and third laminations 6.1, 6.2, 6.3 are provided.

In a second step, the third laminations 6.3 are stacked into at least one partial package 3.1. For example, three first partial packages 3.1 are provided.

In a third step, the first and second laminations 6.1, 6.2 are stacked into a plurality of, for example, two rotation groups 15, wherein the respective rotation group 15 comprises at least two of the first laminations 6.1 and at least one of the second laminations 6.2 arranged between the first laminations 6.1. The rotation group 15 also forms a partial package of the stator laminated core.

In a fourth step, the rotation groups 15 and the at least one partial package 3.1 are stacked to form the stator laminated core 3, wherein a first partial package 3.1 of third laminations 6.3 are arranged between each two rotation groups 15.

In a fifth step, according to FIG. 4A, the stator winding 18 is inserted into the stator slots 5.

In a sixth step, the at least one alignment element 11 according to FIG. 4B and FIG. 4C is inserted into the respective stator insertion hole 10, whereby the first and second laminations 6.1, 6.2 in the respective rotation group 15 according to FIG. 4D are rotated oppositely about the stator axis 7 and the conductor bundles 19 are locally clamped in the stator grooves 5. To facilitate insertion of the alignment element 11 into the stator insertion hole 10 and rotation of the first and second laminations 6.1, 6.2, the alignment element 11 may have a chamfer or an insertion bevel 21 at the leading end.

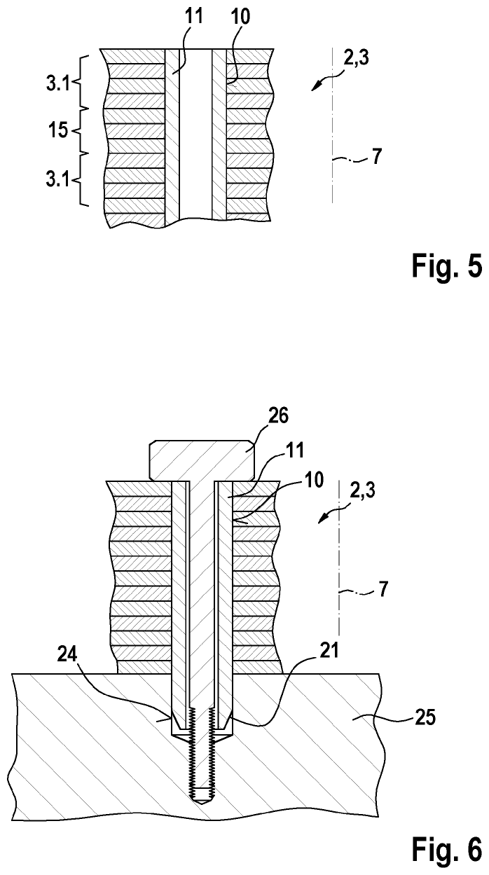

FIG. 5 shows a second exemplary embodiment of the alignment element according to the invention.

According to the second exemplary embodiment, the respective alignment element 11 is, for example, a sleeve.

FIG. 6 shows the second exemplary embodiment of the alignment element according to the invention with a fastening screw inserted through the sleeve for fastening the stator to a machine housing.

The at least one sleeve-shaped alignment element 11 can project through the stator laminated core 3 and into a recess 24, in particular bore 24, of a machine housing 25 for centering the stator laminated core 6. To this end, the respective alignment element 11 is configured longer than the height of the stator laminated core 3.

The sleeve-shaped alignment element 11 according to the second exemplary embodiment allows a fastening screw 26 to be inserted for fastening the stator laminated core 3 to the machine housing 25, which can be part of the electric machine 1 or part of an electrical axis.

Alternatively, the respective alignment element 11 can also be designed in a bolt-shaped fashion in a first region for cooperation with the stator laminated core 3 according to the invention and have a thread in a second area protruding from the stator laminated core for screwing to the machine housing.

1. A stator (2) of an electric machine (1), comprising: a stator laminated core (3), on which stator teeth (4) and stator slots (5) formed between the stator teeth (4) are provided and wherein the stator laminated core (3) is comprised of a stack of laminations (6), wherein the laminations (6) each comprise lamination teeth (8) for forming the stator teeth (4), wherein the stator laminated core (3) comprises a plurality of laminations (6.1, 6.2, 6.3), on each of which at least one leadthrough opening (9) is provided for forming at least one stator insertion hole (10) for inserting a connecting element (11), wherein
first laminations (6.1) are provided, the leadthrough openings (9) of which are each aligned in a circumferential direction relative to a tooth pole center (8m) of a closest lamination tooth (8) of the respective first lamination (6.1) in a first relative alignment (12),
second laminations (6.2) are provided, the leadthrough openings (9) of which are aligned in the circumferential direction relative to a tooth pole center (8m) of a closest lamination tooth (8) of the respective second lamination (6.2) in a second relative alignment (13), wherein the first and second relative alignments (12, 13) are opposite each other in the circumferential direction,
the first and second laminations (6.1, 6.2) are arranged in at least one rotation group (15) comprising at least two of the first laminations (6.1) and at least one second lamination (6.2) arranged between the first laminations (6.1),
the connecting elements (11) are alignment elements that can be inserted in the respective stator insertion hole (10) to generate an opposite rotation of the laminations (6.1, 6.2) of the respective rotation group (15).

2. The stator according to claim 1, wherein the opposite rotation of the laminations (6.1, 6.2) of the rotation groups (15) is achieved by the inserted alignment element (11) displacing the first and second laminations (6.1, 6.2) protruding into the stator insertion hole (10) in the circumferential direction.

3. The stator according to claim 1, wherein a stator yoke (16) connecting the stator teeth (4) is provided, wherein the respective stator insertion hole (10) is formed on a side of the stator yoke (16) facing away from the stator teeth (4).

4. The stator according to claim 1, wherein the respective alignment element (11) is a pin or a sleeve.

5. The stator according to claim 1, wherein the alignment element (11) has a chamfer or conical insertion bevel (21) at a leading end for insertion into the respective stator insertion hole (10).

6. The stator according to claim 4, wherein the respective alignment element (11) is a sleeve, through which a fastening screw (26) for fastening the stator laminated core (3) to a machine housing (25) can be inserted.

7. The stator according to claim 1, wherein the first and second laminations (6.1, 6.2) are configured in a same shape and in the stator laminated core (3) in a mirror-image arrangement relative to each other.

8. The stator according to claim 1, wherein third laminations (6.3) are provided, the respective leadthrough opening (9) of which is aligned in a circumferential direction relative to a tooth pole center (8m) of a closest lamination tooth (8) of the third lamination (6.3) in a third relative alignment (14).

9. The stator according to claim 1, wherein a stator winding (18) running through the stator slots (5) is provided and wherein a local clamping of conductor bundles (19) of the stator winding (18) in the stator slots (5) is achievable due to the rotation of the laminations (6.1, 6.2) of the respective rotation group (15).

10. The stator according to claim 9, wherein the conductor bundle (19) of the respective stator slot (5) is enclosed at least in a region of the respective rotation group (15) by at least one electrically insulating protective jacket (20).

11. An electrical machine having a stator (2) according to claim 1 and having a machine housing (25), wherein the alignment elements (11) pass through the stator laminated core (3) and protrude into recesses (24) of the machine housing (25) for centering the stator laminated core (3).

12. A method for manufacturing a stator (2) according to claim 1, comprising the steps of:
stacking a stator laminated core (3) comprising first and second laminations (6.1, 6.2),
inserting the stator winding (18) into the stator slots (5),
inserting the alignment elements (11) into the stator insertion holes (10), thereby rotating the first and second laminations (6.1, 6.2) opposite to each other about the stator axis (7) and locally clamping the conductor bundles (19) in the stator slots (5).

13. The method according to claim 12, wherein the laminations (6) of the stator laminated core (3) are aligned with each other in a circumferential direction prior to insertion of the alignment elements (11), such that the conductors of the stator winding (18) can be inserted into the stator grooves (5) with clearance.

14. The stator according to claim 1, wherein the alignment element (11) is a pin, bolt, or screw.

15. The stator according to claim 1, wherein the first relative alignment (12) is offset by an offset angle (α), and wherein the second relative alignment (12) is offset by the offset angle (α).

16. The stator according to claim 1, wherein the first and second relative alignments (12, 13) are equal in magnitude.

17. The stator according to claim 8, wherein the third relative alignment (14) is centered on the tooth pole center (8m).

18. The electric machine according to claim 11, wherein the recesses (24) are bores.

19. The method according to claim 12, wherein stacking a stator laminated core (3) further includes third laminations (6.3).

20. The method according to claim 12, wherein insertion of the conductors of the stator winding (18) into the stator grooves (5) with clearance results in substantially aligned lamination teeth (8).
